(19) United States
(12) Patent Application Publication
(10) Pub. No.: US 2010/0001175 A1
(43) Pub. Date: Jan. 7, 2010

(54) IMAGING DEVICE

(76) Inventors: Ryohei Kawamuki, Tenri-shi (JP); Masayuki Nishikawa, Higashiosaka-Shi (JP); Hideaki Fujita, Shiki-Gun (JP)

Correspondence Address: EDWARDS ANGELL PALMER & DODGE LLP, P.O. BOX 55874, BOSTON, MA, 02205, US

(21) Appl. No.: 12/310,097

(22) PCT Filed: Aug. 7, 2007
(86) PCT No.: PCT/JP2007/065439

§ 371 Date: Apr. 17, 2009

(30) Foreign Application Priority Data
Aug. 7, 2006 (JP) 2006-214563

(51) Int. Cl. G02B 6/00

(52) U.S. Cl. 250/227.2

(57) ABSTRACT

A shutter (42) is installed on a second lens frame (14). A first transmissive photosensor (17) is installed on the inner surface of an object-side outer wall (5a) of an optical block first housing (5), while a second transmissive photosensor (18) is installed inside an outer wall (5b) located on a CCD light receiving section side. A first light shielding plate (19) is installed on the surface located on the object side of the first lens frame (11). On the other hand, the second light shielding plate (20) is provided on one side of a light shielding plate installation member (43), and the light shielding plate installation member (43) is installed on a bottom section of the second lens frame (14). By thus installing the second light shielding plate (20) on the opposite side of the second lens frame (14) with respect to the shutter (42), interference between the shutter (42) and the second transmissive photosensor (18) is avoided. Moreover, with an installation such that the projection areas of the second transmissive photosensor (18) and the shutter (42) on a plane normal to the optical axis are partially superposed over each other, the length in a direction normal to the optical axis is reduced.

### TECHNICAL FIELD

The present invention relates to an imaging device that includes a lens driven during optical zooming.

### BACKGROUND ART

Conventionally, an imaging device that has an optical zoom function is known. In such an imaging device, it is possible to perform a change in zoom magnification ratio and focusing by driving in an optical axis direction a moving lens frame that is guided and supported slidably in the optical axis direction.

Further, in the imaging device as described above, a transmissive photosensor is widely used to detect an origin that serves as a reference when the moving lens frame is moved. Then, in order to effect light shielding between the light emitting section and the light receiving section of the transmissive photosensor, a light shielding plate is provided for the moving lens frame.

There is a lens barrel disclosed in JP 2002-258138 A as an imaging device that has a means for detecting the origin that serves as a reference when the moving lens frame is moved. In the lens barrel, a sleeve fitted on a guide member that is fixed to the main body of the lens barrel and extended in the optical axis direction is integrally installed on a lens retaining frame, and a reference position detector constructed of a photo interrupter light shielding plate installed on the sleeve and a photo interrupter mounted on a board located on the main body side of the lens barrel and a movement amount detector constructed of a sensor magnet and an MR sensor installed on the sleeve are provided.

Then, after the lens retaining frame is initially driven to the reference position where the photo interrupter light shielding plate effects light shielding between the light emitting section and the light receiving section of the photo interrupter, the lens retaining frame is driven toward a target position, and a pulse signal outputted from the MR sensor in accordance with the movement of the sensor magnet with respect to the MR sensor is counted. Upon reaching a predetermined count value, the stepping motor is stopped to stop the lens retaining frame at the target position.

As described above, in the lens barrel disclosed in JP 2002-258138 A, wiring is simplified by providing the photo interrupter light shielding plate and the sensor magnet for detecting the amount of movement of the lens retaining frame for the sleeve formed on the lens retaining frame.

However, the conventional lens barrel disclosed in JP 2002-258138 A has the following problems.

In recent years, built-in camera modules of digital cameras and portable equipment are demanded to not only have a high zoom ratio and a high resolution but also be reduced in size. Therefore, components such as a motor as a driving source, lead screws, gears and so on for transmitting motive energy are mounted with high density.

Therefore, when the lens barrel disclosed in JP 2002-258138 A is applied to the built-in camera modules of compact type digital cameras and portable equipment, the means for transmitting a motive energy is located adjacent to the sleeve on which the photo interrupter light shielding plate and the sensor magnet are provided. Accordingly, there arises a problem that it becomes difficult to provide the photo interrupter and the MR sensor at the peripheries of the sleeve and to secure a space for providing the photo interrupter light shielding plate and the sensor magnet for the sleeve itself.

Moreover, a mechanical shutter is mounted to improve image quality in the digital camera and the camera module. In particular, when the shutter is fixed to the lens retaining frame and the lens retaining frame is driven integrally with the shutter, in order to avoid interference between the shutter and the photo interrupter, it is necessary to provide a long distance between them and this further causes a problem that the size reduction becomes difficult.

### SUMMARY OF INVENTION

### Technical Problem

An object of the present invention is to provide an imaging device capable of reducing the outside dimensions by avoiding interference between the shutter integrated with the lens frame and the transmissive photosensor.

### Solution to Problem

In order to achieve the above object, there is provided an imaging device comprising:

a lens that collects light from an object to be photographed;

a lens frame that supports the lens in a manner that the lens can move in an optical axis direction of the lens; and

a transmissive photosensor that detects that the lens frame (14) is located at an origin that serves as a reference during movement, wherein

a light shielding plate that shields light incident on a light receiving section of the transmissive photosensor when the lens frame is located at the origin and a shutter that controls passing of light from the lens to a side opposite from the object are provided for the lens frame, and

the light shielding plate is installed in a space opposite from the lens frame side with respect to the shutter.

According to the above construction, the light shielding plate is installed in the space located opposite from the lens frame side with respect to the shutter. Therefore, the transmissive photosensor can be installed outside the moving ranges of the lens frame and the shutter, and the origin of the lens frame can be detected without mutual interference between the shutter and the transmissive photosensor.

In one embodiment of the invention, the shutter and the light shielding plate are installed in a manner that a projection area of the shutter and a projection area of the light shielding plate on a plane normal to the optical axis are at least partially superposed over each other.

According to the present embodiment, the shutter and the light shielding plate are installed so that the projection areas thereof on the plane normal to the optical axis are at least partially superposed over each other. Therefore, the transmissive photosensor and the shutter can be installed so that the projection area of the transmissive photosensor and the projection area of the shutter on the plane normal to the optical axis are at least partially superposed over each other, and the length of the imaging device in the direction normal to the optical axis can be reduced by the length of superposition.

In one embodiment of the invention, the light shielding plate is comprised of a member separate from that of the lens frame and installed and fixed on the lens frame.

According to the present embodiment, the light shielding plate is constructed of a member different from that of the lens frame. Therefore, the light shielding plate installed in the space located opposite from the lens frame side with respect to the shutter can be installed and fixed simply and reliably to the lens frame which has a robust structure and on which the components are mounted less densely than on the shutter.

In one embodiment of the invention, the imaging device further comprising:

a second lens that has an optical axis identical to the optical axis of the lens and is different from the lens;

a second lens frame that supports the second lens movably in the optical axis direction independently of the lens frame for which the shutter is provided; and

a second transmissive photosensor that detects that the second lens frame is located at a second origin that serves as a reference during movement, wherein

a second light shielding plate that shields light incident on a light receiving section of the second transmissive photosensor is provided for the second lens frame when the second lens frame is located at the second origin, and

the second light shielding plate is installed in a manner that a projection area of the shutter and a projection area of the second light shielding plate on a plane normal to the optical axis are at least partially superposed over each other.

According to the present embodiment, the shutter and the second light shielding plate are installed so that the projection areas thereof on the plane normal to the optical axis are at least partially superposed over each other. Therefore, the second transmissive photosensor and the shutter can be installed so that the projection area of the second transmissive photosensor and the projection area of the shutter on the plane normal to the optical axis are at least partially superposed over each other, and the length of the imaging device in the direction normal to the optical axis can be reduced by the length of superposition.

In one embodiment of the invention, the second light shielding plate is installed in a space located opposite from the lens frame side on which the shutter is provided with respect to the second lens frame.

According to the present embodiment, the second light shielding plate is installed in the space located opposite from the lens frame side on which the shutter is provided with respect to the second lens frame. Therefore, the second transmissive photosensor can be installed outside the moving range of the second lens frame, and the origins of the two lens frames can be detected without mutual interference between the shutter and the two transmissive photosensors even when the superposed portion in the moving range of the two lens frames is large.

### Advantageous Effects of Invention

As is apparent from the above, in the imaging device of the invention, the light shielding plate for shielding light incident on the light receiving section of the transmissive photosensor and the shutter are provided for the lens frame when the lens frame is located at the origin, and the light shielding plate is installed in the space located opposite from the lens frame side with respect to the shutter. Therefore, the transmissive photosensor can be installed outside the moving ranges of the lens frame and the shutter. Therefore, the origin of the lens frame can be detected without mutual interference between the shutter and the transmissive photosensor.

Furthermore, if the shutter and the light shielding plate are installed so that the projection area of the shutter and the projection area of the light shielding plate on the plane normal to the optical axis are at least partially superposed over each other, the transmissive photosensor and the shutter can be installed so that the projection area of the transmissive photosensor and the projection area of the shutter on the plane normal to the optical axis can be at least partially superposed over each other. Therefore, the length of the imaging device in the direction normal to the optical axis can be reduced by the length of superposition.

Furthermore, if the second light shielding plate for shielding light incident on the light receiving section of the second transmissive photosensor is provided for the second lens frame independent of the lens frame when the second lens frame is located at the origin and the second light shielding plate is installed so that the projection area of the shutter on the plane normal to the optical axis and the projection area of the second light shielding plate are at least partially superposed over each other, the second transmissive photosensor and the shutter can be installed so that the projection area of the second transmissive photosensor and the projection area of the shutter on the plane normal to the optical axis can be at least partially superposed over each other. Therefore, the length of the imaging device in the direction normal to the optical axis can be reduced by the length of superposition.

Furthermore, the second light shielding plate is installed in the space located opposite from the lens frame side on which the shutter is provided with respect to the second lens frame, and therefore, the second transmissive photosensor can be installed outside the moving range of the second lens frame. Therefore, the origins of the two lens frames can be detected without mutual interference between the shutter and the two transmissive photosensors even when the superposed portion in the moving ranges of the two lens frames is large.

### BRIEF DESCRIPTION OF DRAWINGS

FIG. 1 is a perspective view of the appearance of the imaging device of the present invention;

FIG. 2 is a view showing a state in which the imaging device shown in FIG. 1 is disassembled into an optical block, a drive block and a CCD board;

FIG. 3 is a view showing a general view of the optical block in FIG. 2;

FIG. 4 is a longitudinal sectional view of an optical block first housing in FIG. 3;

FIG. 5 is a perspective view showing a general view of first and second lens frames in the optical block first housing;

FIG. 6 is a perspective view showing a general view of first and second lens frames different from FIG. 5;

FIG. 7 is a plan view showing a general view of first and second lens frames in the optical block first housing;

FIG. 8 is a perspective view showing the drive block connected to the optical block;

FIG. 9 is a rear view viewed from the CCD board side, showing the drive block connected to the optical block; and

FIG. 10 is an explanatory view of a method for installing a second light shielding plate to the second lens frame.

### DESCRIPTION OF EMBODIMENTS

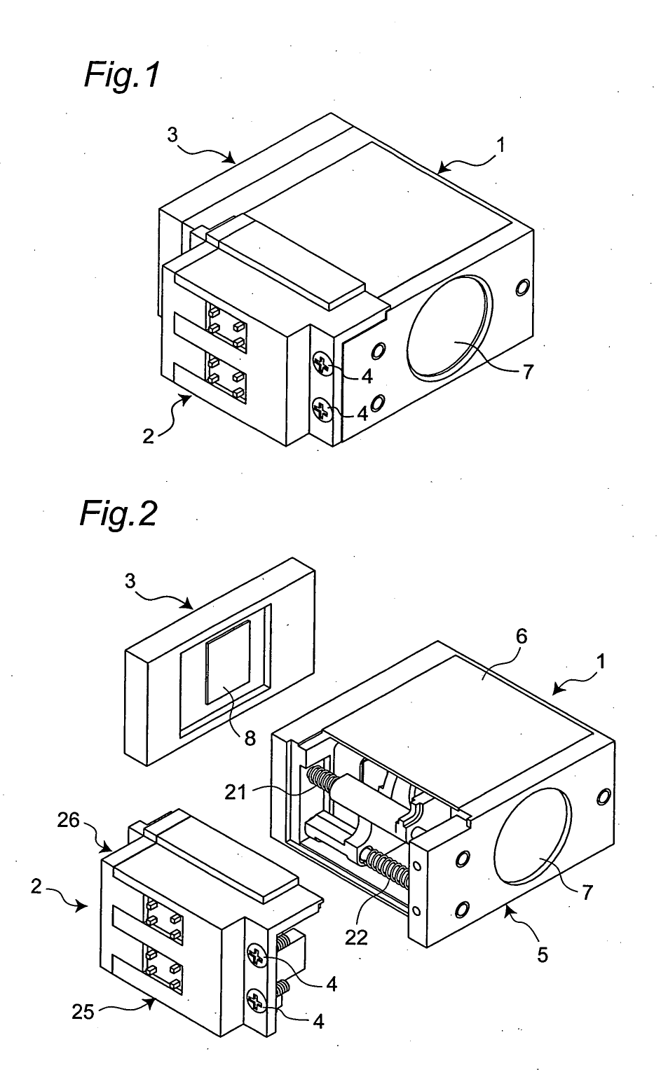

The invention will be described in detail below by the embodiments shown in the drawings. FIG. 1 is a perspective view of the appearance of the imaging device of the present embodiment. FIG. 2 shows a state in which the imaging device shown in FIG. 1 is disassembled into an optical block, a drive block and a CCD (Charge Coupled Device) board. It is noted that the imaging device is a compact imaging device intended to be build in portable equipment.

As shown in FIGS. 1 and 2, the imaging device is generally constituted of an optical block 1 that includes an optical system of lenses and so on, a drive block 2 that includes drive components of a stepping motor and so on for driving the lens frame, and a CCD board 3. The optical block 1 and the drive block 2 are bonded together with screws 4 and adhesive, and the CCD board 3 is bonded to the optical block 1 with adhesive.

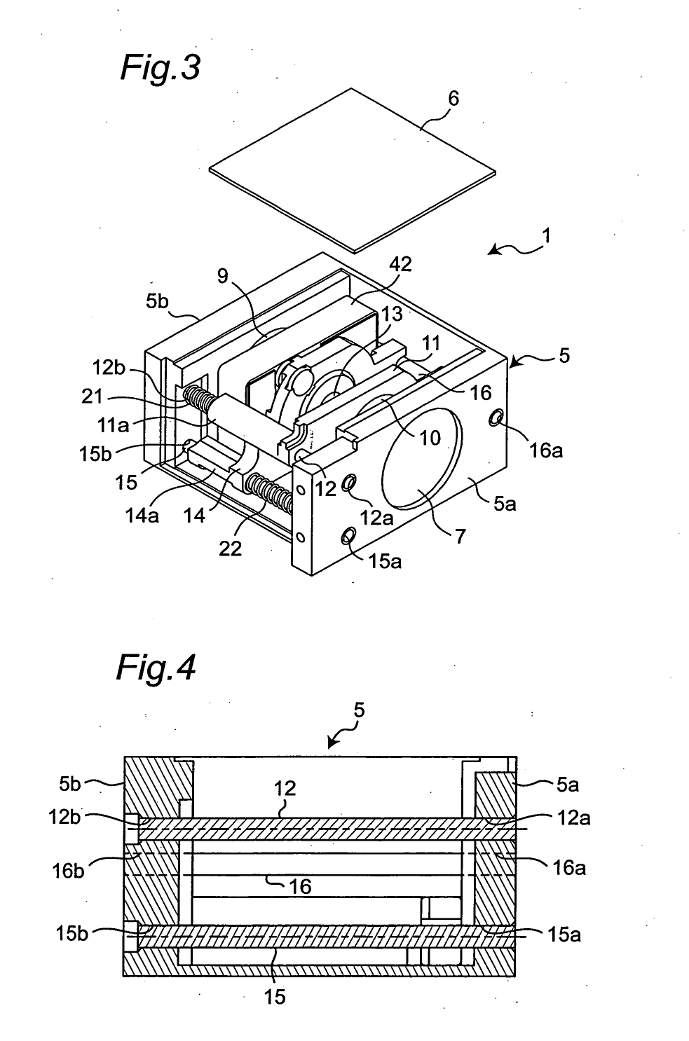

FIG. 3 shows a general view of the optical block 1. The optical block 1 is constituted of an optical block first housing 5 where a lens frame and a guide shaft are received, and an optical block second housing 6 that closes an opening of the optical block first housing 5. The optical block first housing 5 has a large opening to improve assembling workability. Then, by assembling the lens frame and the guide shaft with the optical block first housing 5 and thereafter bonding the optical block second housing 6 to the peripheral portions at the opening of the optical block first housing 5, the opening of the optical block first housing 5 is partially closed. The remaining portion of the opening of the optical block first housing 5 is closed by bonding the drive block 2.

With regard to the optical block first housing 5, an outer wall 5a located nearest to an object to be photographed and an outer wall 5b located nearest to a CCD light receiving section 8 support and fix a first lens 7 and a fourth lens 9, respectively, in a manner that the optical axes thereof coincide with each other.

A first lens frame 11 that supports a second lens 10 has a projection 11a that protrudes in the direction of the optical axis (coinciding with the optical axes of the first and fourth lenses 7, 9) of the second lens 10, and a first main guide shaft 12 is put through an axial hole formed in the optical axis direction of the projection 11a. The first lens frame 11 is thus slidably guided and supported in the optical axis direction. Moreover, a second lens frame 14 that supports a third lens 13 has a projection 14a that protrudes in the direction of the optical axis (coinciding with the optical axes of the first, second and fourth lenses 7, 10, 9) of the third lens 13, and a second main guide shaft 15 is put through an axial hole formed in the optical axis direction of the projection 14a. The second lens frame 14 is thus slidably guided and supported in the optical axis direction. Further, the first lens frame 11 and the second lens frame 14 have guide grooves, and the first and second lens frames 11, 14 are prevented from rotating around the first main guide shaft 12 and the second main guide shaft 15 by a subordinate guide shaft 16 put through the guide grooves.

First main guide bearing portions 12a, 12b that support and fix both ends of the first main guide shaft 12, second main guide bearing portions 15a, 15b that support and fix both ends of the second main guide shaft 15 and subordinate guide bearing portions 16a, 16b that support and fix both ends of the subordinate guide shaft 16 are provided at the optical block first housing 5 that constitutes the housing.

FIG. 4 shows a longitudinal cross section that passes through the axial centers of the first main guide shaft 12 and the second main guide shaft 15 in the optical block first housing 5. The first main guide bearing portion 12a, the second main guide bearing portion 15a and the subordinate guide bearing portion 16a are provided on the object-side outer wall 5a of the optical block first housing 5. Moreover, the first main guide bearing portion 12b, the second main guide bearing portion 15b and the subordinate guide bearing portion 16b are provided at the outer wall 5b located on the CCD board 3 side of the optical block first housing 5. In this case, the first main guide shaft bearing portions 12a, 12b, the second main guide bearing portions 15a, 15b and the subordinate guide bearing portions 16a, 16b are through holes formed in the optical block first housing 5, and the centers of the through holes are parallel to the optical axis. Then, both ends of the first main guide shaft 12, the second main guide shaft 15 and the subordinate guide shaft 16 are press-fit, supported and fixed to the first main guide bearing portions 12a, 12b, the second main guide bearing portions 15a, 15b, and the subordinate guide bearing portions 16a, 16b, respectively.

As described above, the first main guide bearings 12a, 12b, the second main guide bearings 15a, 15b, and the subordinate guide bearings 16a, 16b are formed as an integrated component. Therefore, it is possible to improve the relative positional accuracy by adjusting a metal mold. That is, it is possible to perform adjustment so that the parallelism between the first main guide shaft 12 and the second main guide shaft 15 is improved. Therefore, even if the two main guide shafts exist, the mutual positional accuracy of the lens frames of the first lens frame 11 and the second lens frame 14 is high, and satisfactory optical characteristics can be obtained.

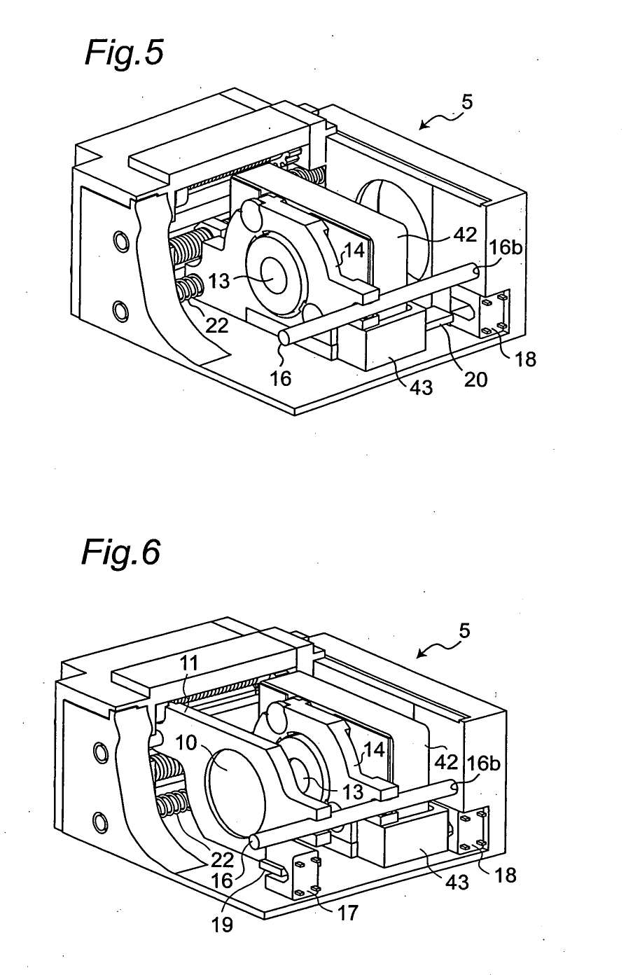

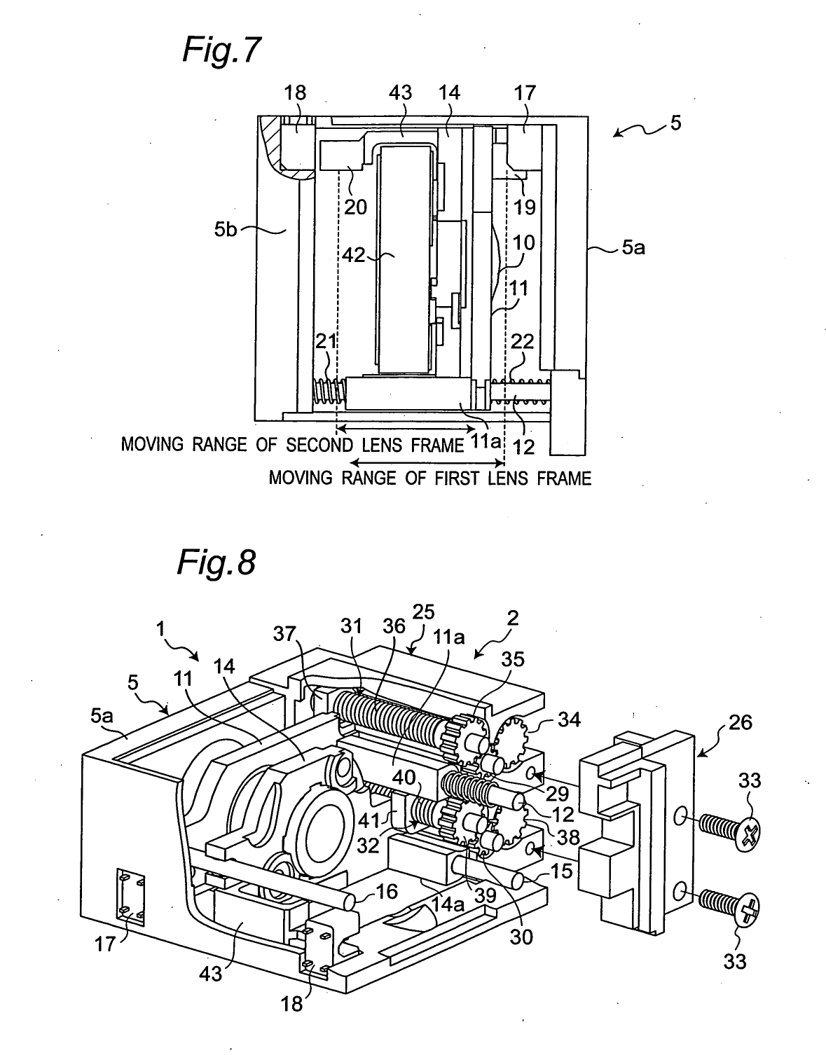

FIGS. 5 and 6 are perspective views showing general views of the first lens frame 11 and the second lens frame 14 in the optical block first housing 5. FIG. 7 is a plan view showing a general view of the first lens frame 11 and the second lens frame 14. The first lens frame 11 supports the second lens 10, the second lens frame 14 supports the third lens 13, and the optical axes of the second lens 10 and the third lens 13 coincide with the optical axes of the first lens 7 and the fourth lens 9.

As shown in FIG. 7, first and second transmissive photosensors 17, 18 are installed as origin sensors for detecting the origins when the first lens frame 11 and the second lens frame 14 are moved in the optical block first housing 5. Moreover, first and second light shielding plates 19, 20 are installed on the first lens frame 11 and the second lens frame 14. Then, by shielding light between the light emitting section and the light receiving section of the first and second transmissive photosensors 17, 18 by the first and second light shielding plates 19, 20, it is detected that the first and second lens frames 11, 14 are located at the origins.

Moreover, a first pressure spring 21 and a second pressure spring 22 for restricting the occurrence of “wobble” during driving by a thrust force applying means by consistently pressurizing the first lens frame 11 and the second lens frame 14 against the thrust force applying means as described later are installed inside the optical block first housing 5. In this case, the first and second pressure springs 21, 22 are placed between the optical block first housing 5 and the first and second lens frames 11, 14, while the first main guide shaft 12 and the second main guide shaft 15 are put through the first pressure spring 21 and the second pressure spring 22, respectively.

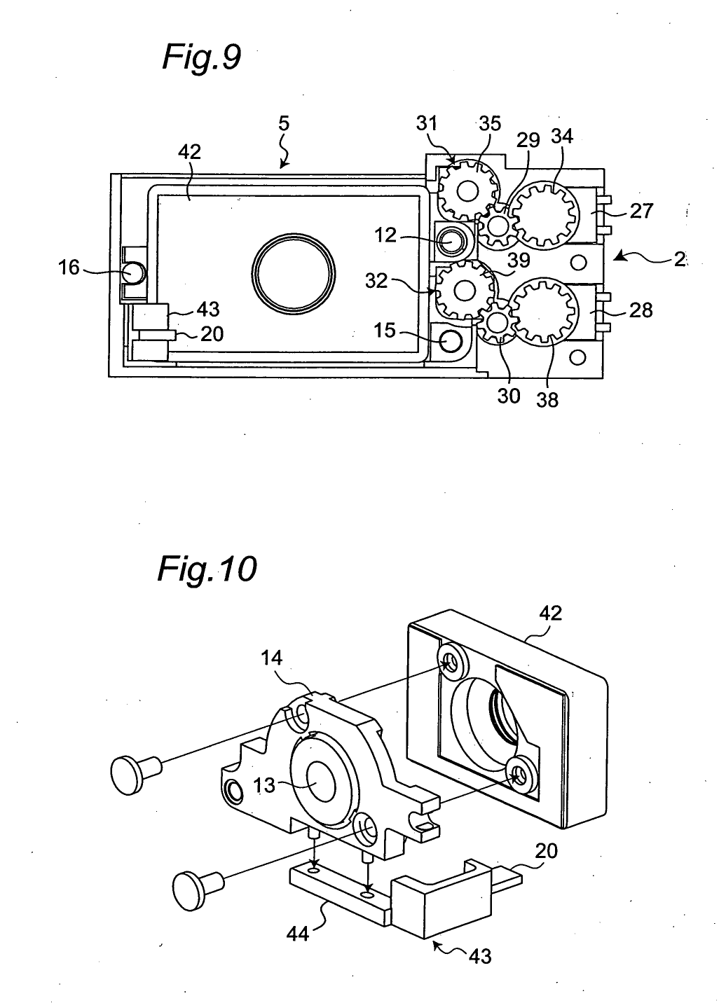

FIGS. 8 and 9 show the drive block 2 connected to the optical block 1. The drive block 2 is constituted of a drive block first housing 25 and a drive block second housing 26. The drive block first housing 25 and the drive block second housing 26 hold a first motor 27, a second motor 28, a first gear 29, a second gear 30, a first lead screw 31 and a second lead screw 32 therebetween, and the drive block first housing 25 and the drive block second housing 26 are fastened together with screws 33.

The first gear 29, the second gear 30, the first lead screw 31 and the second lead screw 32 are rotatably supported around the respective central axes. The first motor 27 is a stepping motor, and an output gear 34 is installed on its output shaft. Then, the output gear 34 is meshed with the first gear 29, and the first gear 29 is meshed with an input gear 35 of the first lead screw 31. A plate-shaped first thrust plate 37 that has a through hole threaded with a female thread is in screw engagement with the output gear 36 of the first lead screw 31, and the first thrust plate 37 is brought in contact with the first lens frame 11 from the object side. In this case, the central axis of the female thread of the first thrust plate 37 is normal to the surface of contact with the first lens frame 11, and therefore, the first thrust plate 37 moves parallel to the central axis of the first lead screw 31 when the first lead screw 31 rotates. Further, the first lead screw 31 is installed parallel to the optical axis of the lens system, and therefore, the rotation of the first motor 27 becomes a thrust force in the optical axis direction of the first lens frame 11.

The second motor 28, an output gear 38 of the second motor 28, the second gear 30, an input gear 39 of the second lead screw 32, an output gear 40 of the second lead screw 32, a second thrust plate 41 and the second lens frame 14 also have structures similar to those of the first motor 27 through the first lens frame 11 described above. However, the second thrust plate 41 is brought in contact with the second lens frame 14 from the CCD board 3 side. That is, the thrust force applying means indicates the first motor 27, the output gear 34 of the first motor 27, the first gear 29, the input gear 35 of the first lead screw 31, the output gear 36 of the first lead screw 31 and the first thrust plate 37, the second motor 28, the output gear 38 of the second motor 28, the second gear 30, the input gear 39 of the second lead screw 32, the output gear 40 of the second lead screw 32 and a second thrust plate 41.

In the imaging device of the present embodiment, the shutter 42 is fixed to the second lens frame 14, and the second lens frame 14 and the shutter 42 are integrally driven by the second motor 28.

In a compact imaging device of a high magnifying power, a closest approach distance between the first lens frame 11 and the second lens frame 14 is short. In addition, as shown in FIG. 7, the first lens frame 11 and the second lens frame 14 have a large superposed portion in the moving ranges thereof. Therefore, when the first and second transmissive photosensors 17, 18 are installed between the first lens frame 11 and the second lens frame 14, the first and second transmissive photosensors 17, 18 interfere with the first and second lens frames 11, 14 and the shutters 42.

Accordingly, in the present embodiment, as shown in FIG. 7, the first and second transmissive photosensors 17, 18 are installed outside the respective moving ranges where the moving range of the first lens frame 11 and the second lens frame 14 are never superposed over each other. In this case, the moving ranges mean the ranges in which the externals of the first and second lens frames 11, 14 including the shutter 42, the second lens 10 and the third lens 13 move. That is, the first transmissive photosensor 17 that detects the origin of the first lens frame 11 is installed and fixed on the inner surface of the outer wall 5a of the optical block first housing 5 located nearest to the object to be photographed. Moreover, the second transmissive photosensor 18 that detects the origin of the second lens frame 14 is installed and fixed inside the outer wall 5b located nearest to the CCD light receiving section 8.

In this case, the shutter 42 is fixed to a surface located on the CCD board 3 side of the second lens frame 14. Accordingly, as shown in FIGS. 7 and 10, a light shielding plate installation member 43 having a bracket-like horizontal cross section shape is formed separately from the second lens frame 14 and the shutter 42. On one and the other sides of the light shielding plate installation member 43, a second light shielding plate 20 and a mounting plate 44 are provided, respectively. Then, the mounting plate 44 of the light shielding plate installation member 43 is fixed to a bottom section of the second lens frame 14. The second light shielding plate 20 is thus installed in a space located opposite from the second lens frame 14 side with respect to the shutter 42 circuiting a side portions of the second lens frame 14 and the shutter 42. With this arrangement, the origin of the second lens frame 14 can be detected without mutual interference between the shutter 42 and the second transmissive photosensor 18.

If the second light shielding plate 20 is installed in a space located on the second lens frame 14 side with respect to the shutter 42, interference occurs between the second transmissive photosensor 18 and the shutter 42 when the second lens frame 14 is moved in the optical axis direction unless the second transmissive photosensor 18 is installed in a manner that the projection area of the second transmissive photosensor 18 and the projection area of the shutter 42 on the plane normal to the optical axis are not superposed over each other.

In contrast to this, when the second light shielding plate 20 is installed as in the present embodiment, the second light shielding plate 20 is located closer to the second transmissive photosensor 18 side than the shutter 42. Therefore, the projection area of the shutter 42 and the projection area of the second light shielding plate 20 on the plane normal to the optical axis are allowed to be partially superposed over each other. With the construction as described above, it is possible to arrange such that the projection area of the second transmissive photosensor 18 and the projection area of the shutter 42 on the plane normal to the optical axis are partially superposed over each other. Therefore, the external of the imaging device can be reduced by the length of superposition.

Moreover, the first light shielding plate 19 on the first lens frame 11 is formed in the space located opposite from the second lens frame 14 having the shutter 42 relative to the first lens frame 11. Therefore, the first transmissive photosensor 17 can be installed outside the moving range of the second lens frame 14, and the interference between the shutter 42 and the first transmissive photosensor 17 can be avoided. Moreover, the first transmissive photosensor 17 can also be installed such that the projection surface of the first transmissive photosensor 17 and the projection surface of the shutter 42 on the plane normal to the optical axis are partially superposed over each other. Therefore, the external of the imaging device can be reduced by the length of superposition.

As described above, in the present embodiment, among the first lens 7, the second lens 10, the third lens 13 and the fourth lens 9, which are installed so as to have the identical optical axis, the second lens 10 and the third lens 13 for performing a change in the zoom magnification ratio and focusing are supported so as to be movable in the optical axis direction by the first lens frame 11 and the second lens frame 14. Further, the shutter 42 is installed and fixed on the second lens frame 14, so that the second lens frame 14 and the shutter 42 are integrally driven.

Then, the first transmissive photosensor 17 that detects the origin of the first lens frame 11 is installed and fixed on the inner surface of the outer wall 5a of the optical block first housing 5 located nearest to the object to be photographed. On the other hand, the second transmissive photosensor 18 that detects the origin of the second lens frame 14 is installed and fixed on the outer wall 5b located nearest to the CCD light receiving section 8. Moreover, when the first lens frame 11 is located at the origin, the first light shielding plate 19 that shields light between the light emitting section and the light receiving section of the first transmissive photosensor 17 is installed on the object-side surface of the first lens frame 11. On the other hand, when the second lens frame 14 is located at the origin, the second light shielding plate 20 that shields light between the light emitting section and the light receiving section of the second transmissive photosensor 18 is provided on one side of the light shielding plate installation member 43 that has a bracket-like cross section shape, and the mounting plate 44 of the light shielding plate installation member 43 is fixed to the bottom section of the second lens frame 14. The second light shielding plate 20 is thus installed in the space located opposite from the second lens frame 14 side with respect to the shutter 42 circuiting the side portions of the second lens frame 14 and the shutter 42.

Therefore, as shown in FIG. 7, even if the superposed portion in the moving ranges of the first lens frame 11 and the second lens frame 14 is large, the origin of the second lens frame 14 can be detected without mutual interference between the shutter 42 and the second transmissive photosensor 18 nor mutual interference between the shutter 42 and the first transmissive photosensor 17.

Moreover, the projection area of the shutter 42 and the projection area of the second light shielding plate 20 on the plane normal to the optical axis, i.e., the projection area of the second transmissive photosensor 18 and the projection area of the shutter 42 on the plane normal to the optical axis can be installed partially superposed over each other. Therefore, the length in the direction normal to the optical axis of the imaging device can be reduced by the length of superposition.

Moreover, the projection area of the shutter 42 and the projection area of the first light shielding plate 19 on the plane normal to the optical axis, i.e., the projection surface of the shutter 42 and the projection surface of the first transmissive photosensor 17 on the plane normal to the optical axis can be installed partially superposed over each other. Therefore, the length in the direction normal to the optical axis of the imaging device can be reduced by the length of superposition.

It is noted that the second light shielding plate 20 installed on the second lens frame 14 is constructed of a member separate from that of the second lens frame 14 in the above embodiment. In this case, there is a method for installing the second light shielding plate 20 on the shutter 42 instead of installing the second light shielding plate 20 on the second lens frame 14. However, since the mechanical components are mounted with high density inside the shutter 42 and the shutter 42 is moved together with the second lens frame 14, the outside dimensions cannot be increased. Moreover, since a light weight is demanded, the outer wall of the shutter 42 is thin, and the installation of the second light shielding plate 20 is difficult. Accordingly, the second light shielding plate 20 is provided on the second lens frame 14 in the present embodiment.

However, it is difficult to integrally form the second lens frame 14, the member provided circuiting the side portion of the shutter 42 and the second light shielding plate 20. Accordingly, the formation of the second light shielding plate 20 is facilitated by constituting the light shielding plate installation member 43 separately from the second lens frame 14 in the present embodiment.

1. An imaging device comprising:
a lens (13) that collects light from an object to be photographed;
a lens frame (14) that supports the lens (13) in a manner that the lens can move in an optical axis direction of the lens (13); and
a transmissive photosensor (18) that detects that the lens frame (14) is located at an origin that serves as a reference during movement, wherein
a light shielding plate (20) that shields light incident on a light receiving section of the transmissive photosensor (18) when the lens frame (14) is located at the origin and a shutter (42) that controls passing of light from the lens (13) to a side opposite from the object are provided for the lens frame (14), and
the light shielding plate (20) is installed in a space opposite from the lens frame (14) side with respect to the shutter (42).

2. The imaging device as claimed in claim 1, wherein
the shutter (42) and the light shielding plate (20) are installed in a manner that a projection area of the shutter (42) and a projection area of the light shielding plate (20) on a plane normal to the optical axis are at least partially superposed over each other.

3. The imaging device as claimed in claim 1, wherein
the light shielding plate (20) is comprised of a member separate from that of the lens frame (14) and installed and fixed on the lens frame (14).

4. The imaging device as claimed in claim 2, comprising:
a second lens (10) that has an optical axis identical to the optical axis of the lens (13) and is different from the lens (13);
a second lens frame (11) that supports the second lens (10) movably in the optical axis direction independently of the lens frame (14) for which the shutter (42) is provided; and
a second transmissive photosensor (17) that detects that the second lens frame (11) is located at a second origin that serves as a reference during movement, wherein
a second light shielding plate (19) that shields light incident on a light receiving section of the second transmissive photosensor (17) is provided for the second lens frame (11) when the second lens frame (11) is located at the second origin, and
the second light shielding plate (19) is installed in a manner that a projection area of the shutter (42) and a projection area of the second light shielding plate (19) on a plane normal to the optical axis are at least partially superposed over each other.

5. The imaging device as claimed in claim 4, wherein
the second light shielding plate (19) is installed in a space located opposite from the lens frame (14) side on which the shutter (42) is provided with respect to the second lens frame (11).
